(19) United States
(12) Patent Application Publication
(10) Pub. No.: US 2026/0151979 A1
(43) Pub. Date: Jun. 4, 2026

(54) MULTI-PIECE CONTAINER FORMING SYSTEM

(71) Applicant: Marq Packaging Systems II, LLC, Yakima, WA (US)

(72) Inventor: Spencer Marquis, Yakima, WA (US)

(21) Appl. No.: 18/968,965

(22) Filed: Dec. 4, 2024

(51) Int. Cl. B31B 50/04; B31B 50/62; B31B 105/00

(52) U.S. Cl. CPC B31B 50/046; B31B 50/624; B31B 2105/00

(57) ABSTRACT

A multi-piece container forming assembly is provided. The assembly has a mandrel movable by a ram assembly between a raised position and a lowered position, a container base panel loading assembly configured to deliver a container base panel below the mandrel, and a container side panel loading assembly. The container side panel assembly can include a hopper assembly arranged with an upward slope toward the mandrel and having a pusher plate configured to advance container side panels upward with a ratcheting motion toward the mandrel, and a pivotable side panel delivery assembly at the second upper end. The side panel delivery assembly can have a suction coupling member rotatable between a first position configured to couple to the container side panel located in the hopper assembly, and a second position configured to release the container side panel when in contact with the mandrel in the raised position.

### BACKGROUND

A wide variety of containers are used in the packaging industry to transport, store, and display goods. Certain types of goods, such as non-self-supporting goods, require durable packaging with high stacking strength to protect the integrity of the contained goods during stacked transport, storage, and display. One type of such container is a multi-piece container called a bliss box, or bliss case, which is often specified for its structural strength, versatility, and protection of the goods contained therein. Unlike standard corrugated paper boxes, bliss boxes are generally formed by joining multiple corrugated panels, in some examples three panels, to create a more durable container with reinforced corners and edges. The demand for bliss boxes is particularly high in industries such as food and beverage, consumer goods, and e-commerce, where secure and robust packaging is essential.

Traditionally, the production of bliss boxes involves multiple steps, often requiring manual handling or separate machines to form each panel and join them into a single container. This multi-step process can be labor-intensive, time-consuming, and susceptible to inconsistencies, resulting in inefficiencies and increased production costs. Moreover, manual assembly processes can lead to variations in box quality, impacting the performance of bliss boxes under rigorous handling conditions.

To address these limitations, the industry has shifted towards automated bliss box forming machines. Such machines aim to streamline the production process by integrating steps such as panel feeding, folding, gluing, and assembly into a single, continuous operation. Despite advancements in box forming automation, there are still challenges in achieving high-speed, precise, and reliable bliss box assembly, particularly with varying box sizes and materials. Current technology bliss box forming machines require significant operator involvement to maintain adequate feed stock of box panel pieces, often in an ergonomically disadvantageous manner. An effective bliss box forming machine should be capable of consistently producing high-quality boxes with minimal operator intervention, downtime, waste, and energy consumption. Additionally, there is a need for machines that can handle variable box dimensions and designs, and material inconsistencies, allowing for greater flexibility in production without the need for extensive retooling or setup.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIGS. 1A and 1B are perspective views of a multi-piece container forming system, in accordance with embodiments of the present disclosure;

FIGS. 2A and 2B are perspective views of the multi-piece container forming system of FIGS. 1A and 1B, with external paneling, support structure, auxiliary equipment, and certain other components of the system hidden for component visibility purposes;

FIG. 3A is a perspective view and FIG. 3B is a cross-sectional side view, each of a container side panel loading assembly of the multi-piece container forming system of FIGS. 1A and 1B, shown with a container side panel loaded into a pusher plate of a ratcheting hopper assembly;

FIG. 3C is a perspective view and FIG. 3D is a detail view, each of the container side panel loading assembly of FIGS. 3A and 3B, with additional structural components hidden for visibility purposes related to a ratcheting chain-advance system;

FIG. 3E is a detail view of an upper portion of the container side panel loading assembly of FIGS. 3A and 3B, showing a pivotable side panel delivery assembly interfacing with the container side panel positioned against the pusher plate of the ratcheting hopper assembly;

FIGS. 3F and 3G are cross-sectional side views of the upper portion of the container side panel loading assembly of FIG. 3E, with FIG. 3F showing the pivotable side panel delivery assembly interfacing with the container side panel positioned against the pusher plate of the ratcheting hopper assembly, and FIG. 3G showing the pivotable side panel delivery assembly rotated such that the container side panel is positioned against a mandrel of the multi-piece container forming system;

FIGS. 4A and 4B are cross-sectional side views of a ram assembly having the mandrel and an articulable forming and compression system of the multi-piece container forming system of FIG. 1, with the mandrel in an elevated position in FIG. 4A to receive pieces of the multi-piece container, and in a lowered position in FIG. 4B to form the multi-piece container against the articulable forming and compression system;

FIG. 4C is a detailed perspective view of a portion of the mandrel and one articulable compression assembly of the articulable forming and compression system of FIGS. 4A and 4B; and

FIG. 4D is a perspective view of one articulable compression assembly of the articulable forming and compression system of FIGS. 4A and 4B.

### DETAILED DESCRIPTION

The detailed description set forth herein connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

As will be described in more detail below, the present disclosure provides examples of multi-piece container forming systems that produce assembled multi-piece containers, also referred to as bliss boxes. Bliss boxes are often specified for their structural strength, versatility, and protection of the goods contained therein, such as those used in food and beverage, consumer goods, and e-commerce industries. Unlike standard corrugated paper boxes, bliss boxes are formed by joining multiple corrugated panels, in some examples three panels, to create a more durable container with reinforced corners and edges.

Traditionally, the production of multi-piece containers, such as bliss boxes, involved multiple steps, which often required manual handling or separate machines to form each panel and join them into a single container. The multi-piece container forming systems of the present disclosure, which may be referred to herein as bliss box forming machines, are expected to streamline the production process by integrating the steps of panel feeding, folding, gluing, and assembly into a single, continuous operation. Embodiments of the multi-piece container forming systems disclosed herein include container side panel loading assemblies located on either side of the system to provide continuous loading of container side panels onto a mandrel of the ram assembly and subsequently into the container forming section of the system. The side panel loading assemblies are each configured with a ratcheting hopper arranged with an upward slope such that gravity urges the container side panels to rest against and stay stationary with respect to a pusher plate, which is movable along the slope of the ratcheting hopper.

The ratcheting hopper is configured to cooperate with a pivotable side panel delivery assembly positioned at an upper end of each of the container side panel loading assemblies. During operation of the system, a stack of one or more container side panels are advanced up the slope of the ratcheting hopper by the pusher plate and into position to be manipulated by the pivotable side panel delivery assembly. In the illustrated embodiments, the pivotable side panel delivery assembly includes a suction coupling portion that releasably couples the container side panel thereto, permitting the pivotable side panel delivery assembly to rotate and deliver each container side panel to the mandrel, at which point the suction is removed to release the container side panel from the suction coupling portion. After release of the delivered container side panel, the pivotable side panel delivery assembly can then rotate back into position to manipulate a subsequent container side panel atop the ratcheting hopper.

The multi-piece container forming systems of the present disclosure are expected to deliver high-speed, precise, and reliable bliss box assemblies, particularly with varying box sizes and material blemishes and/or inconsistencies, allowing greater flexibility in production, increased throughput, and less waste. To achieve these and other goals, the container forming section of the system can include an articulable forming and compression system having one or more articulable compression members. The articulable compression members can be arranged adjacent to the mandrel in its lowered position and can articulate to provide even pressure against glue patch areas of the container panels to ensure proper adhesion. The articulable compression members can include an upper forming guide portion that can adjust to variations in the panel thickness to provide consistent panel forming (i.e., folding around the mandrel).

Although the multi-piece container forming systems are shown and described herein as capable of forming multi-piece containers from a base panel and two side panels, other panel configurations are within the scope of the present disclosure, for example, more than one base panel, a single side panel or more than two side panels, etc. Examples of auxiliary systems, such as the control system, the adhesive delivery system, and the like are shown for illustrative purposes and could be modified in any suitable manner to cooperate with the multi-piece container forming system components disclosed herein. One skilled in the relevant art will appreciate that the disclosed embodiments are illustrative in nature and therefore should not be construed as limited to these applications. It should therefore be apparent that the disclosed technologies and methodologies have wide application, and therefore may be suitable for use with many types of multi-piece container forming configurations. Accordingly, the following descriptions and illustrations herein should not limit the scope of the claimed subject matter. Further, certain components of the system have not been described in detail as to not unnecessarily obscure various aspects of the present disclosure, for example, structural components, motor drive systems, paneling, control systems, etc.

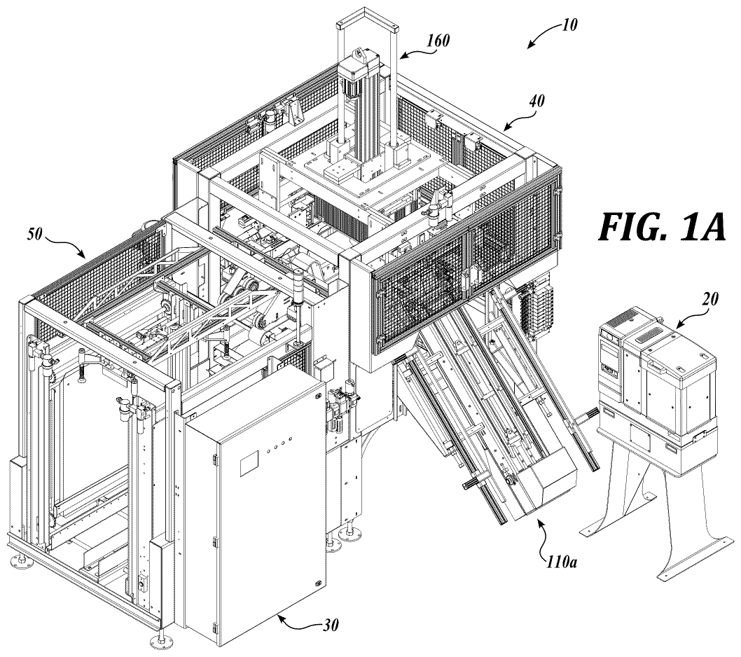

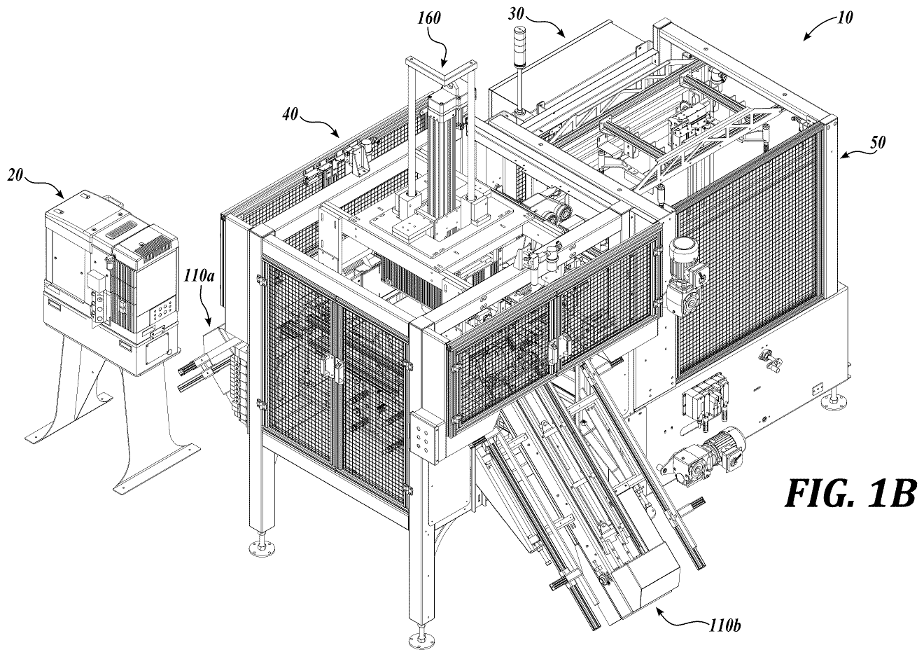

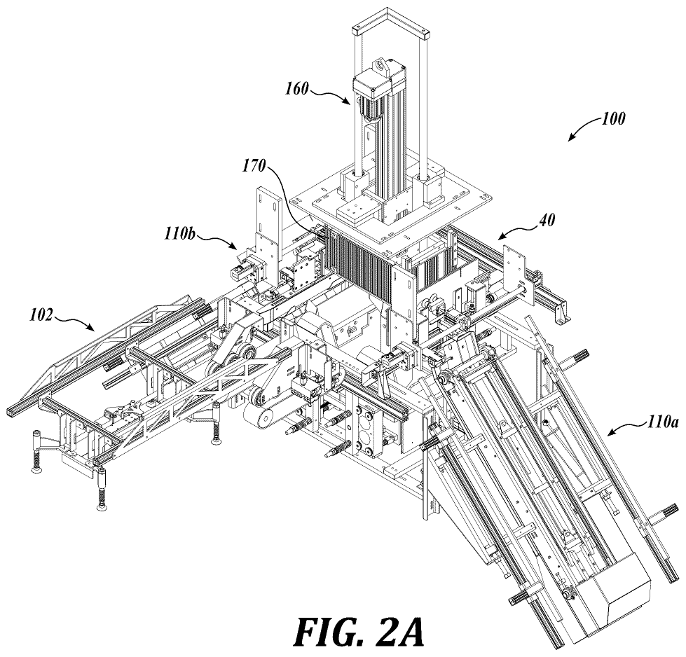

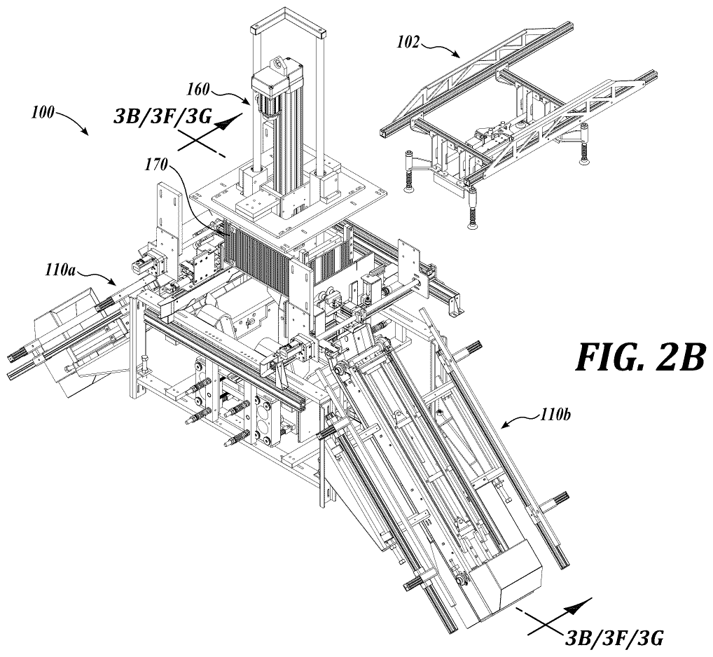

FIGS. 1A and 1B are perspective views of a multi-piece container forming system 10 (hereinafter “system 10”), in accordance with embodiments of the present disclosure. The system 10 can include various auxiliary components intended to support forming of the multi-piece containers, such as adhesive delivery system 20, a control system 30, a multi-piece container forming system 40, and a container base panel loading system 50. That adhesive delivery system 20 can be configured to apply glue to the mating portions of the multi-piece container panels during forming of the multi-piece containers. The system 10 shown in FIGS. 1A and 1B omits certain components between the adhesive delivery system 20 and the system 10 for clarity in the FIGURES, for example, glue lines, glue nozzles, electrical and data connections, control components, etc. Similarly, the control system 30 is shown as a generic enclosure in the FIGURES, and in the installed state would include various control systems, components, electrical and data connections, and the like. In FIGS. 2A-4C, various structural members, control components, paneling, etc. are hidden such that components of the embodiments of the present disclosure can be more clearly seen. Omission of each of these components is intended to not unnecessarily obscure various aspects of the present disclosure.

The multi-piece container forming system 40 (hereinafter “forming system 40”) of the system 10 can include subassemblies that provide various operations during forming of the multi-piece containers. In this regard, the forming system 40 can include first and second container side panel loading assemblies 110a and 110b, and a ram assembly 160. As will be described in greater detail below, the first and second container side panel loading assemblies 110a and 110b include components to retain stacks of multiple container side panels, deliver the side panels to a mandrel of the ram assembly 160 to be mated to a container base panel delivered by the container base panel loading system 50, and permit reloading of the side panel stacks by operators as needed during operation of the system 10. The delivery of the side panels to the mandrel is performed by a vacuum assembly that forms a suction coupling with the container side panel and rotates the panel into position with the mandrel. In this regard, the first and second container side panel loading assemblies 110a and 110b provide continuous loading of the system 10.

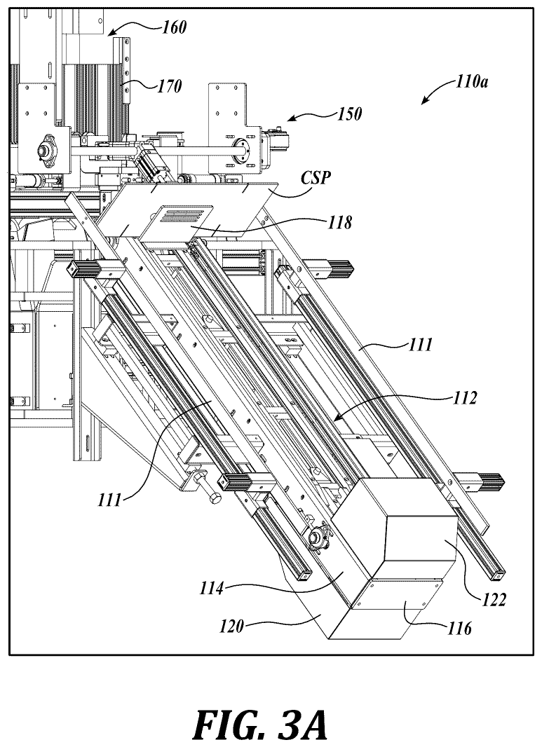

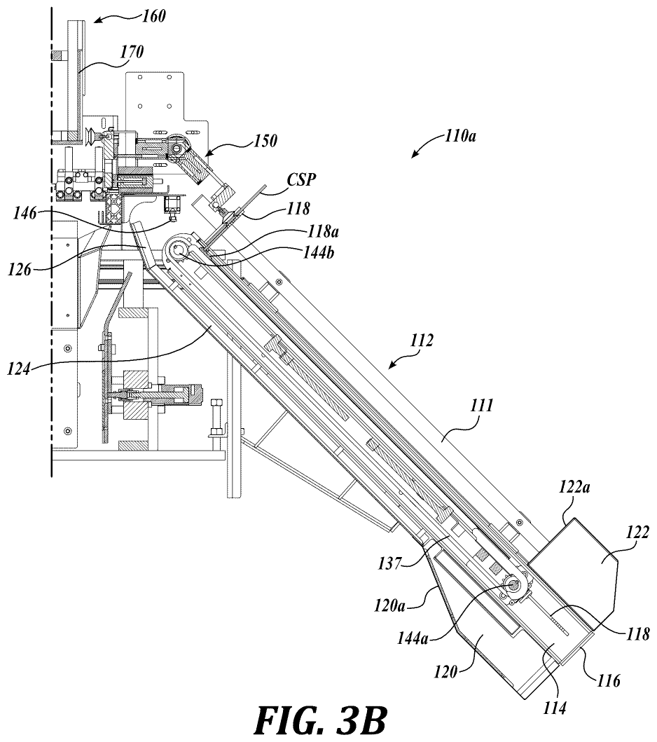

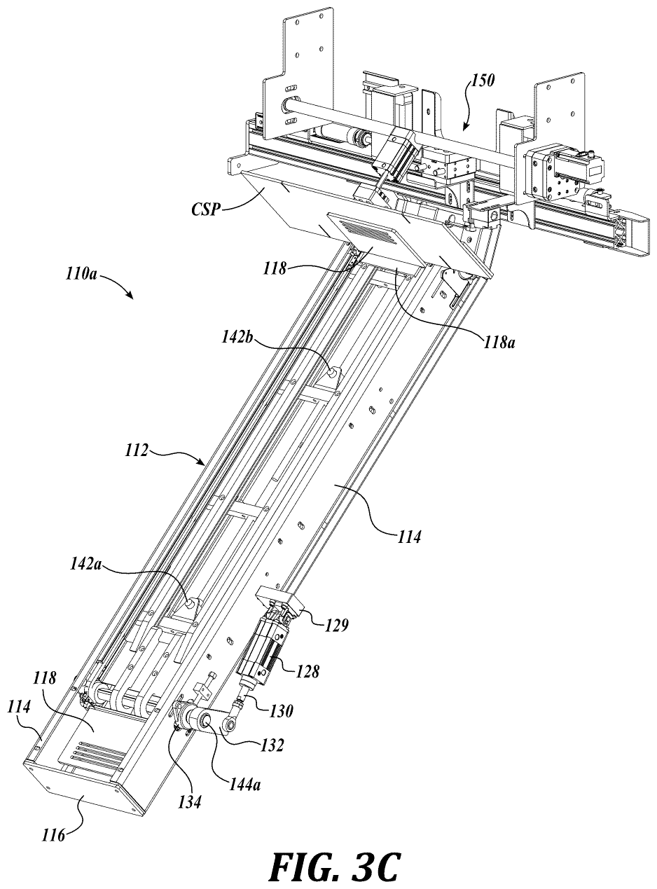

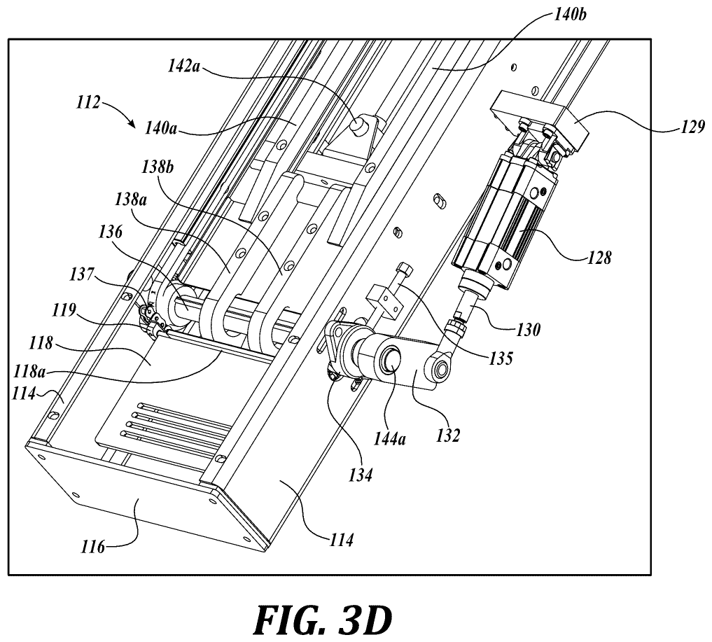

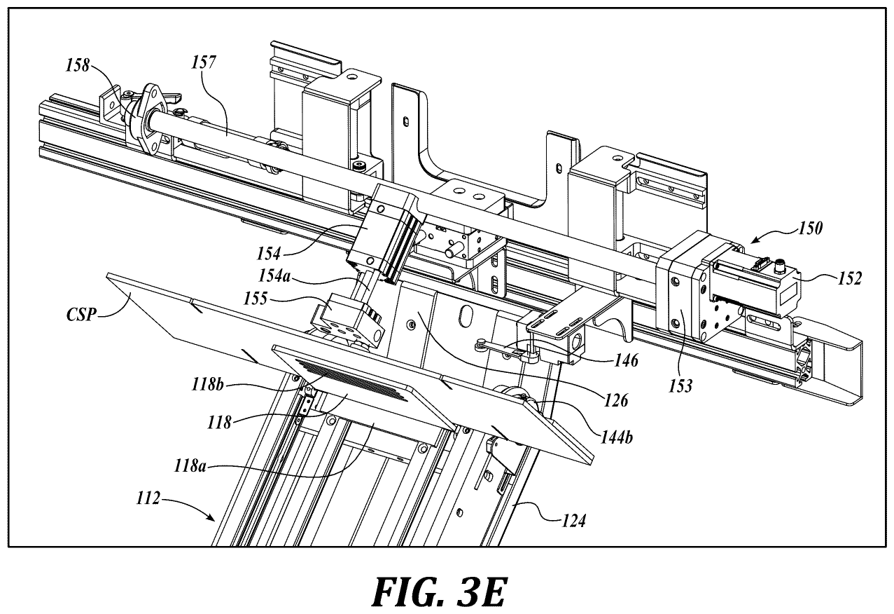

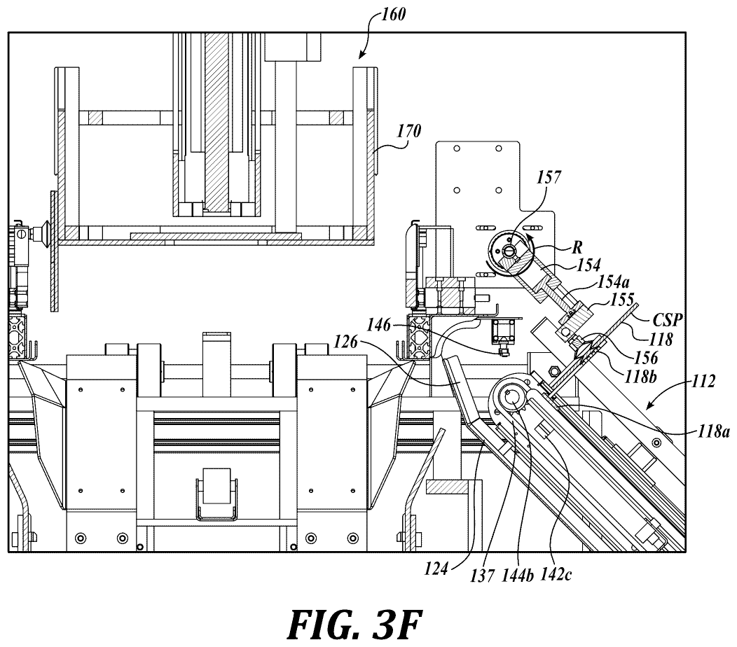

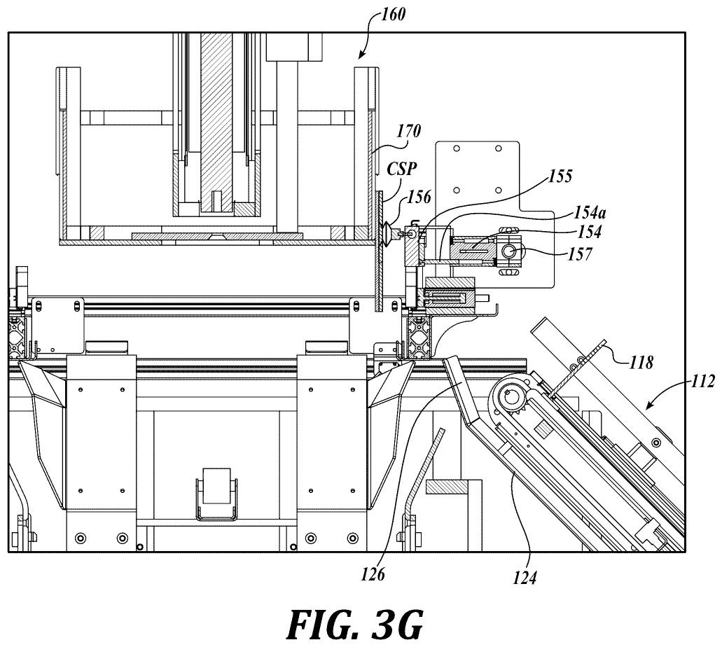

FIGS. 2A and 2B are perspective views of the system 10, with various external paneling, support structure, auxiliary equipment, and certain other components of the system 10 hidden for sub-component visibility purposes. As shown, the first and second container side panel loading assemblies 110a and 110b can be arranged on either side of the ram assembly 160 within the forming system 40. The base panel loading system 50 can include a base panel suction carriage 102 configured to lift the container base panels (not shown) and deliver the panels to the forming system 40 (e.g., on a belt, roller, etc.), such that a mandrel 170 can form the multi-piece container from the container base panel and the container side panels delivery by the first and second container side panel loading assemblies 110a and 110b. The first and second side panel loading assemblies 110a and 110b can be positioned with respect to the ram assembly 160 with an upward slope such that gravity urges the container side panels to rest against and stay stationary with respect to a pusher plate, which delivers the container side panels to the vacuum assembly (see, e.g., FIGS. 3E-3G).

FIG. 3A is a perspective view and FIG. 3B is a cross-sectional side view, taken along the section line shown in FIG. 2B, each of the first container side panel loading assembly 110a of the system 10. The first container side panel loading assembly 110a is shown positioned adjacent to the ram assembly 160 and the mandrel 170. Several of the structural and other auxiliary components shown in FIGS. 3A and 3B are not labeled or described herein for purposes of clarity in the ensuing description. The first container side panel loading assembly 110a includes a ratcheting hopper assembly 112 configured to advance a pusher plate 118 at an upward slope while carrying at least one container side panel CSP (for example, a stack of container side panel CSP). A stack of the container side panels CSP can be aligned with respect to each other and positioned on the pusher plate 118 (e.g., generally centered) by a pair of guide rails 111 arranged on either side of the ratcheting hopper assembly 112. The container side panels CSP are carried upward along the ratcheting hopper assembly 112 to a position near the top where the container side panels CSP can be manipulated by a pivotable side panel delivery assembly 150, which will be explained in greater detail with respect to FIGS. 3E-3G.

The ratcheting hopper assembly 112 can include a frame for structural rigidity, in the illustrated embodiment having a pair of side rails 114 and a crossbeam 116 at a pusher plate return end of the ratcheting hopper assembly 112. The pusher plate return end can have a lower safety enclosure 120 and an upper safety enclosure 122 that are configured to prevent operator contact with the pusher plate 118 as it rotates from a lower side of the ratcheting hopper assembly 112 to an upper side, where the pusher plate 118 can then be reloaded with a stack of container side panels CSP. As will be explained in detail below with respect to the return path of the pusher plate 118, the lower safety enclosure 120 can have a ramp portion 120a that permits rotation of the pusher plate 118 toward a perpendicular configuration with respect to a ratcheting drive chain 137 (see also, FIG. 3D).

Turning to FIG. 3B, the components enabling the return path of the pusher plate 118 permit continuous feeding of container side panels CSP and a plurality of pusher plates 118 to be attached to the ratcheting drive chain 137 such that a continuous stack of container side panels CSP can be loaded into the first container side panel loading assembly 110a during use of the system 10. In this regard, when each of the plurality of pusher plates 118 reaches the highest point of the ratcheting hopper assembly 112 and the final container side panel CSP is delivered to the ram assembly 160 by the pivotable side panel delivery assembly 150, the pusher plate 118 is permitted to pivot about a pivotable coupling 119 (see, e.g., FIG. 3D) with respect to the ratcheting drive chain 137. The return path of the pusher plate 118 is positioned below the ratcheting drive chain 137 along a pusher plate ramp 124. The pusher plate ramp 124 can include a portion of the lower safety enclosure 120, including its ramp portion 120a. As the pusher plate 118 reaches an upper end roller 144b of the ratcheting hopper assembly 112, the pusher plate 118 rotates toward an angled portion 126 of the pusher plate ramp 124 which guides the pusher plate 118 to a more parallel orientation with respect to the ratcheting drive chain 137. In these embodiments, the pivotable coupling 119 travels first down the pusher plate ramp 124, with the plate portion of the pusher plate 118 following behind the pivotable coupling 119.

Continuing along the return path, the pusher plate 118 travels down the pusher plate ramp 124 and reaches a lower end roller 144a of the ratcheting hopper assembly 112. At this lower end roller 144a, an end of the pusher plate 118 opposite the pivotable coupling 119 interfaces with the ramp portion 120a to initiate rotation of the pusher plate 118 about the pivotable coupling 119. This rotation is in an opposite direction from the rotation at the upper end roller 144b. Rotation from the generally parallel state of the pusher plate 118 with the ratcheting drive chain 137 to the more perpendicular state can be assisted by one or more biasing members (e.g., a spring, not shown) such that the pusher plate 118 returns to the generally perpendicular configuration with respect to the ratcheting drive chain 137 as the pusher plate 118 travels around the lower end roller 144a as generally shown in FIG. 3B. Following the rotation of the pusher plate 118 around the lower end roller 144a, the pusher plate 118 can emerge from the upper safety enclosure 122 and be loaded with further container side panels CSP by the operator. In these embodiments, the pusher plate 118 is pivotably coupled to the ratcheting drive chain 137 during the entire path of the pusher plate 118 through the ratcheting hopper assembly 112. In other embodiments, the pusher plate 118 can be released from the ratcheting drive chain 137 at the upper end roller 144b, more freely slide down the pusher plate ramp 124, and then reattach itself to the ratcheting drive chain 137 near the lower end roller 144a. Although this configuration is not shown, it is within the scope of the present disclosure.

FIG. 3C is a perspective view and FIG. 3D is a detail view, each of the first container side panel loading assembly 110a and the ratcheting hopper assembly 112, with additional structural components hidden for visibility purposes related to a ratcheting chain-advance system that is configured to drive the ratcheting drive chain 137 around the upper and lower end rollers 144a and 144b. The chain-advance system drives the ratcheting drive chain 137 in a stepped manner such that the container side panels CSP are positioned to be manipulated by the pivotable side panel delivery assembly 150. In this regard, the steps of the chain-advance system can be as short as advancing the ratcheting drive chain 137 by a thickness of one of the container side panels CSP, or can be the length of the thickness of any number of the container side panels CSP, with adjustments for the position of the container side panel CSP made within the pivotable side panel delivery assembly 150 as will be explained in greater detail below with respect to FIGS. 3E-3G. In some embodiments, the ratcheting drive chain 137 is advanced by a length between about 1/16″ and about 2″, by a length between about 1/16″ and about 1″, by a length between about 1/16″ and about ¾″, by a length between about ⅛″ and about ⅝″, by a length between about ⅜″ and about ⅝″, or by a length of about ½″.

The ratcheting chain-advance system includes a linear actuator 128 that is mounted to, e.g., a mounting block 129 projecting from a side rail 114. The linear actuator 128 can comprise any suitable linear actuator component to effect a linear push/pull motion to advance the ratcheting drive chain 137. In some embodiments, the linear actuator 128 is a pneumatic actuator; however, the linear actuator can be hydraulic, electronic, magnetic, etc. the linear actuator 128 includes a shaft 130 that is extendable and retractable based on instructions sent to the linear actuator 128 by the control system 30. The shaft 130 can be coupled to the lower end roller 144a through a lever arm 132, permitting the linear actuator 128 to rotate the lower end roller 144a by the amount of the linear translation of shaft 130. For example, in the configuration shown in FIGS. 3C and 3D, as the linear actuator 128 pushes the shaft 130 outward from the linear actuator 128, the lower end roller 144a rotates in a counterclockwise direction based on the orientation of FIG. 3B. This counterclockwise rotation of the lower end roller 144a causes the ratcheting drive chain 137 on the upper side of the ratcheting hopper assembly 112 to advance up the slope, causing the pusher plate 118 carrying the container side panel CSP to likewise advance up the slope, delivering the container side panel CSP to the pivotable side panel delivery assembly 150.

Returning to FIGS. 3C and 3D, the lower end roller 144a is operably coupled to the side rails 114 of the ratcheting hopper assembly 112 through one-way clutch bearings 134 adjustably mounted to each of the side rails 114. The one-way clutch bearings 134 including drive shaft 136 extending therebetween, which is operably coupled to the ratcheting drive chain 137. The one-way clutch bearings 134 transfer rotation of the lower end roller 144a to the drive shaft 136 in only a single direction of rotation, and decouple transfer of rotation in the opposite direction. In the illustrated embodiment, the one-way clutch bearings 134 transfer rotation of the lower end roller 144a to the drive shaft 136 in the counterclockwise direction, and decouple transfer of rotation of the lower end roller 144a to the drive shaft 136 in the clockwise direction, each based on the orientation of FIG. 3B. In this regard, as the linear actuator 128 translates the shaft 130 to extend out of the body of the linear actuator 128, the lever arm 132 imparts the counterclockwise rotation on the lower end roller 144a, which in turn rotates the drive shaft 136 in the counterclockwise direction. However, as the linear actuator 128 translates the shaft 130 to retract into the body and the linear actuator 128, the lever arm 132 imparts the clockwise rotation on the lower end roller 144a, but the one-way clutch bearings 134 decouple this rotation direction such that the drive shaft 136 does not rotate. The mechanism described above results in a ratcheting chain advancement up the slope of the ratcheting hopper assembly 112, carrying the pusher plate 118 and the container side panel CSP to the pivotable side panel delivery assembly 150. In some embodiments, the operable coupling between the side rails 114 and the one-way clutch bearings 134 can include adjustable slots such that a chain tensioner 135 can provide proper tension to the ratcheting drive chain 137.

During lifting of the container side panels CSP up the slope of the ratcheting hopper assembly 112, the pusher plate 118 carries weight that must be supported other than by the ratcheting drive chain 137. As shown in FIG. 3D, the pusher plate 118 can have a baseplate portion 118a that contacts guide rails as the pusher plate 118 travels up the slope of the ratcheting hopper assembly 112. The ratcheting hopper assembly 112 can include a first pair of guide rails 138a and 138b and a second pair of guide rails 140a and 140b. The spacing of each of the pairs of the guide rails 138 and 140 can be any suitable spacing, where the illustrated embodiment includes a narrower spacing between the first pair of guide rails 138 to provide clearance to the one-way clutch bearings 134, wherein the second pair of guide rails 140 has a wider spacing for support of the pusher plate 118 as it is loaded with container side panels CSP. The guide rails 138 and 140 can be manufactured by a low friction, low wear material, such as low friction plastics (e.g., Polytetrafluoroethylene (PTFE), High-Density-Polyethylene (HDPE), and the like), roller arrays (not shown), needle and/or ball roller bearings (not shown). In these embodiments, the low friction material can be specified to reduce wear on the components of the system 10 during use.

As described above with respect to FIG. 3B, when each of the plurality of pusher plates 118 reaches the highest point of the ratcheting hopper assembly 112, the pusher plate 118 reaches the end of contact with the second pair of guide rails 140 and is permitted to pivot about a pivotable coupling 119 (see, e.g., FIG. 3D) with respect to the ratcheting drive chain 137, rotating down below to the return path of the pusher plate 118. As the pusher plate 118 rotates forward around the upper end roller 144b, the pusher plate 118 while engage a switch 146 (see also, FIG. 3E) that sends a signal to the control system 30 that the next pusher plate 118 is in position for advancing container side panels CSP up the slope of the ratcheting hopper assembly 112. Although the illustrated embodiment in FIG. 3B shows two pusher plate 118, one at the upper end of the ratcheting hopper assembly 112, and one at the lower end rotating around the lower end roller 144a, in other embodiments, the ratcheting hopper assembly 112 can have a single pusher plate 118, or greater than two pusher plates 118. Having multiple pusher plates 118 permits a more continuous feeding of the container side panels CSP into the ram assembly 160.

Returning to FIG. 3C, the ratcheting hopper assembly 112 can include a system to prevent an empty pusher plate 118 from advancing up the slope of the ratcheting hopper assembly 112. In one embodiment, the ratcheting hopper assembly 112 can have one or more monitoring features that sense the presence of the container side panels CSP atop the ratcheting hopper assembly 112. In the illustrated embodiment shown in FIG. 3C, the ratcheting hopper assembly 112 includes a first photo eye 142a and a second photo eye 142b positioned to sense whether the pusher plates 118 are carrying the container side panels CSP, which will inform the system 10 as to whether to feed a container base panel into the ram assembly 160. The ratcheting hopper assembly 112 can include a third photo eye 142c (see, FIG. 3F) that senses whether a container side panel CSP is ready for loading by the pivotable side panel delivery assembly 150. For example, during use, when the first pusher plate 118 advances toward the top of the slope of the ratcheting hopper assembly 112, one or more further container side panels CSP can be loaded onto the ratcheting hopper assembly 112 between the guide rails 111, resting against a surface 122a of the upper safety enclosure 122 to await a second pusher plate 118, shown in the FIGURES rotating around the lower end roller 144a. During use, the first photo eye 142a will sense the presence of an additional stack of container side panels CSP if they have been loaded atop the ratcheting hopper assembly 112, such that when the illustrated pusher plate 118 that is rotating around the lower end roller 144a engages the additional stack of container side panels CSP, the system 10 knows that at least some of the container side panels CSP are loaded. The second photo eye 142b can sense when the first panel of the additional stack of container side panels CSP passes, and can relay this information to the system 10 so that the ratcheting chain-advance system can advance the ratcheting drive chain 137 up the slope of the ratcheting hopper assembly 112 to eliminate the gap between the empty pusher plate 118 at the top of the slope and the first of the additional stack of container side panels CSP, without loading a container base panel to the ram assembly 160. In some embodiments, if the upper pusher plate 118 is emptied such that the third photo eye 142c no longer senses container side panels CSP, and the first photo eye 142a does not sense a new stack of additional container side panels CSP, the system 10 will pause until the operator loads more container side panels CSP, after which the system 10 will resume forming the multi-piece containers.

FIG. 3E is a detail view of an upper portion of the container side panel loading assembly 110a, showing the pivotable side panel delivery assembly 150 interfacing with the container side panel CSP positioned against the pusher plate 118 of the ratcheting hopper assembly 112. The pivotable side panel delivery assembly 150 is generally configured to releasably couple to a container side panel CSP carried by the pusher plate 118, and rotate the container side panel CSP upward and toward the mandrel 170 of the ram assembly 160, where the pivotable side panel delivery assembly 150 releases the container side panel CSP. After the container side panel CSP is released, further operations to form the multi-piece container are performed, and the pivotable side panel delivery assembly 150 rotates back into a position to releasably couple to a subsequent container side panel CSP. In the illustrated embodiment, the releasable coupling is a suction coupling with a movable suction cup; however, in other embodiments other couplings are within the scope of the present disclosure, such as a mechanical coupling or the like.

The pivotable side panel delivery assembly 150 includes a reversible stepper motor 152 that is operably coupled to a rotating shaft 157 through a gearbox 153. The rotating shaft 157 can be carried by, e.g., the gearbox 153 and a roller bearing 158 such that the rotating shaft 157 is free to rotate axially based on control system rotation of the reversible stepper motor 152 in either rotational direction. The rotating shaft 157 can carry one or more suction cup actuators 154 that are operably coupled to the rotating shaft 157 in a rotationally fixed manner. The rotating shaft 157 may include an aperture (not shown) to ensure rotation of the suction cup actuator 154 with the rotating shaft 157. The suction cup actuator 154 can include one or more extendable rods 154a that can be translated axially by the suction cup actuator 154 to engage the container side panel CSP. The extendable rods 154a can include a suction cup module 155 at an end of the extendable rods 154a opposite the suction cup actuator 154. The suction cup module 155 can be configured to draw a vacuum within one or more suction coupling members 156 (e.g., suction cups 156; see, FIG. 3F), and accordingly provide suction thereto to releasably couple and carry the container side panel CSP to the ram assembly 160. The pusher plate 118 can include a plurality of apertures 118b, shown as slots in the FIGURES, which prevent the suction cups 156 from forming a suction coupling with the pusher plate 118, protecting the pivotable side panel delivery assembly 150 from damage. In some embodiments, the suction cups 156 and/or the extendable rods 154a can be configured to accommodate variation and thickness of the container side panels CSP, and in this regard, can handle the thickness variation without damage to the components or interruption in the multi-piece container forming process.

The operation of the pivotable side panel delivery assembly 150 will now be explained in greater detail. FIGS. 3F and 3G are cross-sectional side views, taken along the section line shown in FIG. 2B, of the upper portion of the container side panel loading assembly 110a, with FIG. 3E showing the pivotable side panel delivery assembly 150 interfacing with the container side panel CSP positioned against the pusher plate 118 of the ratcheting hopper assembly 112, and FIG. 3G showing the pivotable side panel delivery assembly 150 rotated such that the container side panel CSP is positioned against the mandrel 170 of the forming system 40. As shown in FIG. 3F, the position of the pivotable side panel delivery assembly 150 is rotated to engage with the container side panel CSP position against the pusher plate 118. From this position, the rotating shaft 157 rotates in the direction of arrow R, rotating the suction cup actuator 154, the extendable rods 154a, the suction cup module 155, the suction cups 156, and the suction coupled container side panel CSP. These components rotate in the direction of arrow R until the position shown in FIG. 3G, where the container side panel CSP is positioned against the mandrel 170, where suction is released by the suction cup module 155 from the container side panel CSP, freeing the container side panel CSP to be formed around the mandrel 170 by the forming system 40. After the suction is released by the suction cup module 155, the rotating shaft 157 rotates in a direction opposite arrow R to return the components of the pivotable side panel delivery assembly 150 to engage with another container side panel CSP. In this regard, each rotation of the pivotable side panel delivery assembly 150 with a container side panel CSP permits the system 10 to create one complete multi-piece container.

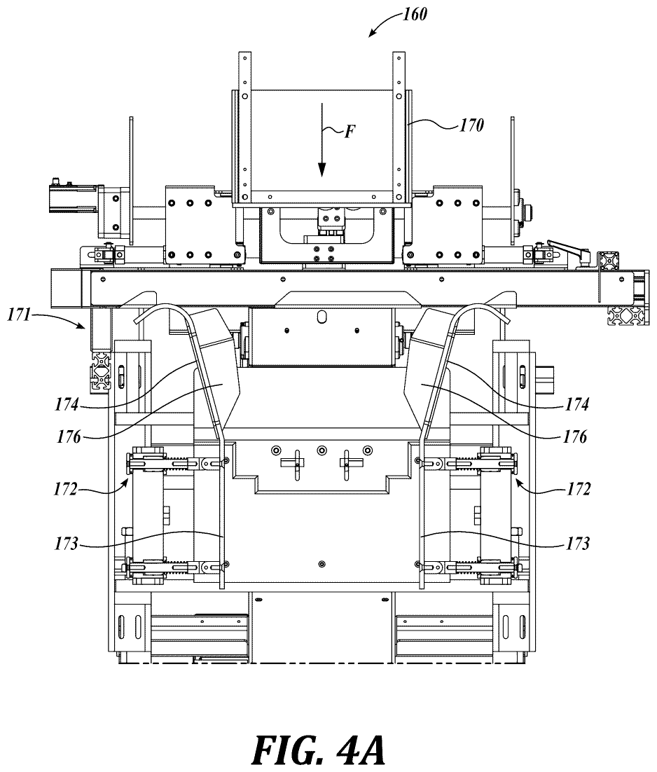

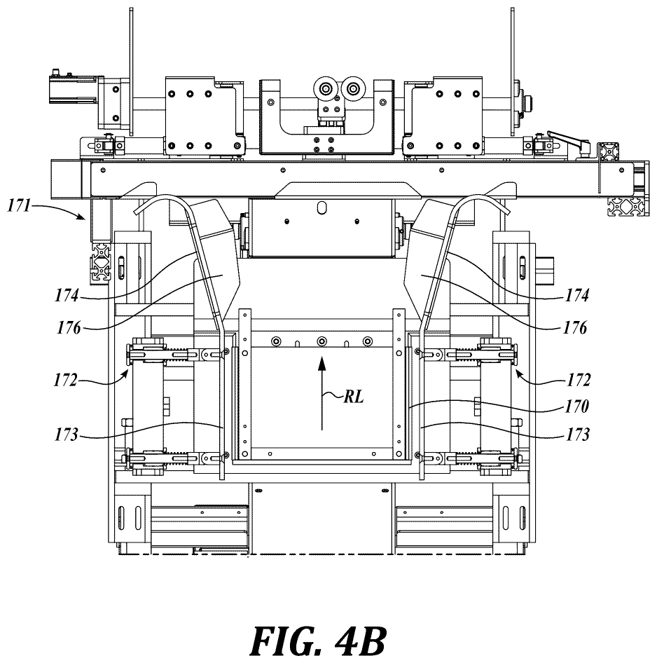

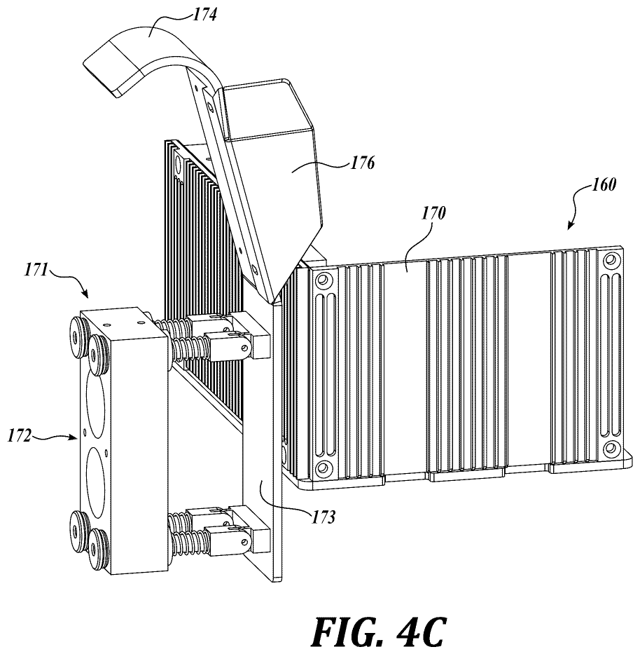

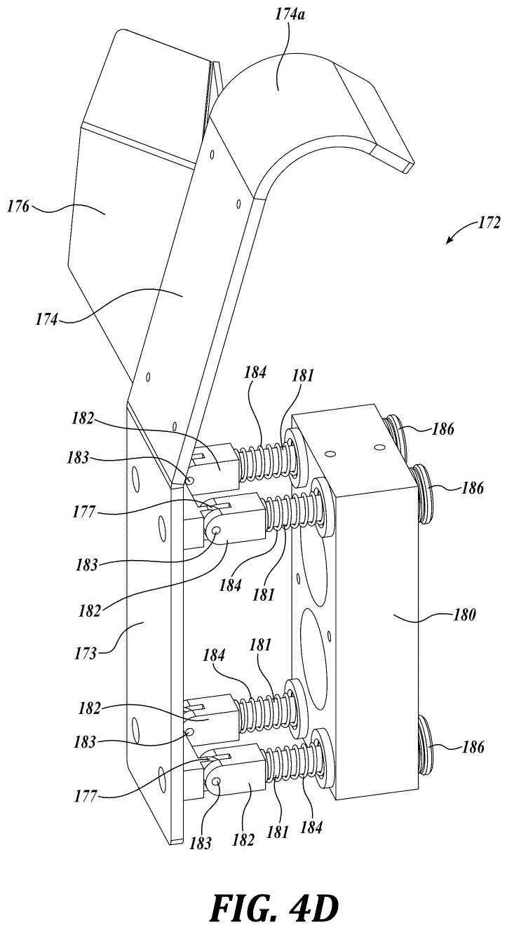

FIGS. 4A and 4B are cross-sectional side views and FIG. 4C is a detailed perspective view of the ram assembly 160 having the mandrel 170 and an articulable forming and compression system 171 of the forming system 40, with the mandrel in an elevated position in FIG. 4A to receive the side container pieces CSP and the container base panel of the multi-piece container, and in a lowered position in FIGS. 4B and 4C to form the multi-piece container against the articulable forming and compression system 171. As shown in FIG. 4A, the articulable forming and compression system 171 includes a plurality of articulable compression assemblies 172 (as shown in FIG. 4D) that each have a glue compression panel 173, a first directing ramp 174, and a second directing ramp 176. When container side panels CSP and a container base panel are delivered to the mandrel 170, the ram assembly 160 lowers the mandrel 170 in the forming direction of arrow F. As the mandrel 170 travels downward in the orientation of FIG. 4A, portions of the panels of the multi-piece container are directed into position for adhesion by the first and second directing ramps 174 and 176, until the mandrel 170 reaches a position as shown in FIG. 4B, where the portions of the multi-piece container to be glued together are positioned between the mandrel 170 and the glue compression panel 173 of the articulable forming and compression system 171.

In the position shown in FIGS. 4B and 4C, the articulable compression assemblies 172 are capable of articulating with respect to the mandrel 170 such that any differences in thickness, material inconsistencies, glue thickness, etc. can be accommodated by the articulable compression assemblies 172, such that the glue compression panels 173 provide generally even pressure across the surface to ensure proper adhesion between the container side panels CSP and the container base panel. After forming the multi-piece container, the ram assembly 160 raises the mandrel 170 in the release direction of arrow RL. Upon release, the articulable compression assemblies 172 returned to their fully extended positions, as will be explained in detail below with respect to FIG. 4D. Although the illustrated embodiments include four articulable compression assemblies 172 located adjacent to each corner of the mandrel 170, in other embodiments fewer or more than four articulable compression assemblies 172 can be used to ensure proper adhesion between the panels of the multi-piece container.

FIG. 4D is a perspective view of one articulable compression assembly 172, having the glue compression panels 173, and the first and second directing ramps 174 and 176. The first directing ramp 174 can include a rounded entry portion 174a that is configured to ensure portions of the container side panel CSP and or the container base panel are directed along the first directing ramp 174 and between the glue compression panels 173 and the mandrel 170. The articulable compression assembly 172 can further include a main body 180 that is configured to operably couple to a portion of the forming system 40, rods 181 having pivot heads 182 each with a pivot pin 183 extending therethrough, springs 184, and stopping ends 186 on the rods 181 opposite the pivot heads 182. The pivot heads 182 are pinned to the glue compression panel 173 at protrusion blades 177 such that the glue compression panel 173 is articulable with facts to the main body 180. The springs 184 are configured to bias the pivot heads 182 away from the main body 180 and rest against the stopping ends 186 in an equilibrium state. As the glue joints of the multi-piece container are lowered by the mandrel 170 into contact with the glue compression panels 173, the thickness variations between the portions of the multi-piece container will cause forces against the glue compression panels 173, compressing the springs 184 and moving the stopping ends 186 away from the main body 180. Although the configuration shown in FIG. 4D with the protrusion blades 177 extending into slots in the pivot heads 182 will generally cause compression of the two upper springs 184 and/or the two lower springs 184 simultaneously, some degree of articulation between spring pairs can be expected based on tolerances in the articulable compression assembly 172.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known components, systems, and/or process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone or “A and B.” Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A multi-piece container forming assembly, comprising:
a mandrel movable by a ram assembly between a raised position and a lowered position;
a container base panel loading assembly configured to deliver a container base panel below the mandrel; and
a container side panel loading assembly, having:
a hopper assembly arranged with an upward slope toward the mandrel and having a pusher plate configured to advance a container side panel from a first lower end to a second upper end at a top of the upward slope nearest the mandrel; and
a pivotable side panel delivery assembly at the second upper end and having a suction coupling member rotatable between a first position in which the suction coupling member is configured to couple to the container side panel located in the hopper assembly, and a second position in which the suction coupling member is configured to release the container side panel when adjacent to the mandrel in the raised position,
wherein moving the mandrel from the raised position to the lowered position forms the multi-piece container from the container base panel and the container side panel.

2. The multi-piece container forming assembly of claim 1, wherein the container side panel loading assembly is a first container side panel loading assembly, and wherein the multi-piece container forming assembly further comprises a second container side panel loading assembly arranged on an opposite side of the mandrel from the first container side panel loading assembly, the second container side panel loading assembly having:
a second hopper assembly arranged with an upward slope toward the mandrel and having a second pusher plate configured to advance a second container side panel from a third lower end to a fourth upper end at a top of the upward slope of the second hopper assembly nearest the mandrel; and
a second pivotable side panel delivery assembly at the fourth upper end and having a second suction coupling member rotatable between a first position in which the second suction coupling member is configured to couple to the container side panel located in the second hopper assembly, and a second position in which the second suction coupling member is configured to release the container side panel when adjacent to the mandrel in the raised position.

3. The multi-piece container forming assembly of claim 1, wherein the hopper assembly includes a plurality of pusher plates coupled to a drive chain for moving the plurality of pusher plates with respect to the hopper assembly to advance the container side panels from the first lower end to the second upper end.

4. The multi-piece container forming assembly of claim 1, wherein the hopper assembly further comprises a drive chain operably coupled to the pusher plate to move the pusher plate with respect to the hopper assembly, wherein the drive chain is movable in a ratcheting motion by a linear actuator rotatably coupled to a lower end roller of the hopper assembly.

5. The multi-piece container forming assembly of claim 4, wherein the lower end roller is operably coupled to the drive chain through a one-way clutch bearing that is operable to: transfer rotation of the lower end roller to the drive chain in a first direction of rotation; and decouple transfer of rotation in a second direction of rotation opposite the first direction.

6. The multi-piece container forming assembly of claim 1, wherein the suction coupling member is a suction cup module operable to draw a vacuum within a suction cup to releasably couple the container side panel to the pivotable side panel delivery assembly.

7. The multi-piece container forming assembly of claim 6, wherein the first position includes the suction cup being positioned adjacent to the pusher plate with the container side panel located therebetween, and wherein the second position includes the suction cup being positioned adjacent to the mandrel with the container side panel located therebetween.

8. The multi-piece container forming assembly of claim 1, further comprising a glue delivery system configured to deliver glue to glue patch areas between the container base panel and the container side panel.

9. The multi-piece container forming assembly of claim 8, further comprising an articulable forming and compression system having glue compression panel positioned adjacent to the mandrel in the lowered position, wherein the glue compression panel is configured to apply pressure to the glue patch areas.

10. The multi-piece container forming assembly of claim 9, wherein the glue compression panel is articulable based on a thickness of the container base panel and a thickness of the container side panel.

11. The multi-piece container forming assembly of claim 1, wherein the hopper assembly further comprises a photo eye operable to sense the presence of a container side panel in the hopper assembly.

12. The multi-piece container forming assembly of claim 1, wherein the hopper assembly has an upper side for receiving the container side panels against the pusher plate, and a lower side for returning the pusher plate to the first lower end of the hopper assembly.

13. The multi-piece container forming assembly of claim 12, wherein the pusher plate follows a return path along the lower side of the hopper assembly, wherein the hopper assembly further comprises an angled projection and a ramp portion along the return path to guide the pusher plate to the first lower end.

14. The multi-piece container forming assembly of claim 13, wherein the hopper assembly further comprises a safety enclosure at the first lower end, and wherein the safety enclosure has a surface against which one or more container side panels can be arranged prior to engagement with the pusher plate traveling along the return path to the first lower end.

15. A container side panel loading assembly for a multi-piece container former, the container side panel loading assembly comprising:
a hopper arranged with an upward slope toward a mandrel;
a pusher plate movable along the hopper and configured to advance a container side panel from a first lower end of the hopper to a second upper end of the hopper at a top of the upward slope nearest the mandrel;
a pivotable side panel delivery assembly positioned at the second upper end and having:
a shaft rotatable by a motor; and
an actuator rotatably fixed to the shaft and operable to translate a suction coupling member with respect to the shaft,
wherein the motor is operable to position the actuator in a first position in which the actuator translates the suction coupling member into contact with the container side panel located in the hopper, and in a second position in which the actuator translates the suction coupling member away from the container side panel after release and when the container side panel is adjacent to the mandrel.

16. The container side panel loading assembly of claim 15, wherein the suction coupling member has a suction coupling module operable to draw a vacuum within a suction cup to releasably couple the container side panel to the pivotable side panel delivery assembly.

17. The container side panel loading assembly of claim 16, wherein the first position includes the suction cup being positioned adjacent to the pusher plate with the container side panel located therebetween, and wherein the second position includes the suction cup being positioned adjacent to the mandrel with the container side panel located therebetween.

18. The container side panel loading assembly of claim 15, wherein the hopper includes a plurality of pusher plates coupled to a drive chain for moving the plurality of pusher plates with respect to the hopper to advance the container side panels from the first lower end to the second upper end.

19. The container side panel loading assembly of claim 15, wherein the hopper further comprises a drive chain operably coupled to the pusher plate to move the pusher plate with respect to the hopper, wherein the drive chain is movable in a ratcheting motion by a linear actuator rotatably coupled to a lower end roller of the hopper.

20. The container side panel loading assembly of claim 15, wherein the hopper further comprises a photo eye operable to sense the presence of a container side panel in the hopper.

21. The multi-piece container forming assembly of claim 15, wherein the hopper has an upper side for receiving the container side panels against the pusher plate, and a lower side for returning the pusher plate to the first lower end of the hopper.

22. The container side panel loading assembly of claim 21, wherein the pusher plate follows a return path along the lower side of the hopper, wherein the hopper further comprises an angled projection and a ramp portion along the return path to guide the pusher plate to the first lower end.

23. The container side panel loading assembly of claim 22, wherein the hopper further comprises a safety enclosure at the first lower end, and wherein the safety enclosure has a surface against which one or more container side panels can be arranged prior to engagement with the pusher plate traveling along the return path to the first lower end.
